(19) United States
(12) Patent Application Publication
(10) Pub. No.: US 2004/0197689 A1
(43) Pub. Date: Oct. 7, 2004

(54) Scratch resistant organic photoreceptor

(76) Inventors: Benzion Landa, Nes ziona (IL); Mark Sandler, Rehovot (IL)

Correspondence Address: William H Dippert, Reed Smith, 29th Floor, 599 Lexington Avenue, New York, NY, 10022-7650, US

(21) Appl. No.: 10/487,744

(22) PCT Filed: Aug. 30, 2001
(86) PCT No.: PCT/IL01/00818

(51) Int. Cl. G03G 15/04

(52) U.S. Cl. 430/67

(57) ABSTRACT

A photoreceptor comprising a support layer and a photoconductive layer, wherein at least a portion of an exposed surface of the photoreceptor is roughened.

### FIELD OF THE INVENTION

The present invention is related to the field of imaging systems and in particular to the prevention of scratches on photoreceptors in imaging systems.

### BACKGROUND OF THE INVENTION

One of the recurring problems in the art of electrographic imaging is the problem of scratching of photoreceptors. This problem, which generally manifests itself in the presence of, generally white, lines in printed or copies images. These scratches are generally produced along a circumference of a roller type photoreceptor when a paper fiber or other relatively hard material is pressed against the surface of the rotating photoreceptor, by a squeegee or cleaning blade.

PCT Publications WO 96/07955 and WO 97/39385, the disclosures of which are incorporated herein by reference, describe various organic photoreceptors in the form of rectangular sheets that are mounted on a drum to form a rotating photoreceptor. As with many organic photoreceptors, the disclosed photoreceptor is formed of three main layers, namely a support layer, such as of Mylar or the like which provides strength to the photoreceptor, a conducting layer overlying the backing layer and a photoconductive layer (which may itself comprise several sub-layers) overlying the conducting layer. Optionally, an underlayer, under the support layer is provided. This layer may be of cloth, such as an open weave cloth or a paper. In the absence of the underlayer, particles trapped under the support layer may cause a slight raising of the surface of the photoreceptor, resulting in image spots and damage of the photoreceptor. The function of the underlayer is to trap particles so that they do not press against the support layer. The underlayer may be attached to the backing layer or it may be attached to the drum on which the photoreceptor is mounted. As known in the art, organic photoreceptors can have additional layers such as adhesive layers (under the support layer) or protective layers (over the photoconductive layer).

As described in the above referenced patent publications, some of the layers may be removed from the ends of the sheets.

FIGS. 1A and 1B show a photoreceptor sheet 12 mounted on a drum 10, utilizing a locking mechanism 14. The sheet has a first end 16 inserted into mechanism 14 and a second end 18 that overlays the first end to protect the locking mechanism from the entry of toner and particles. The sheet, as shown in more detail in FIGS. 2A-2D, has, in an operating portion 150, thereof, an underlayer 151 of cloth or the like, a support layer 152, a conducting layer 154 and a photoconductive layer 156. At end 16, shown in detail in FIG. 2C, photoconductive layer 156 is removed to expose conductive layer 154 (supported by support layer 152). When this end is inserted into locking mechanism 14, a cam 144 presses conductive layer against a surface 20, which is part of (conducting) drum 10. In some embodiments, the cam comprises a cantilevered compressing element. Grounding (or electrification) of the drum thus results in the grounding (or electrification) of the conductive layer.

End 18 of the photoreceptor has both photoconductive layer 156 and conductive layer 154 removed, to expose the Mylar support layer. These layers are removed, so that the surface of the photoreceptor on the drum does not have as high a bump on it as would be present were all the layers kept on end 18. Other embodiments having the same general construction as the construction shown in FIGS. 1 and 2 are disclosed in the references. In particular, the exposed conducting layer is preferably covered (for example with a polymer material) to avoid problems during charging of the photoreceptor and during contact of an electrified squeegee member with the photoreceptor.

Also shown on FIG. 1 is a scraper blade 22 which is used (generally as part of a larger cleaning system) to remove toner and/or other particles, such as paper particles, that remain on photoreceptor 12 after an image developed on it is transferred to a further surface such as paper of an intermediate transfer member.

This prior art photoreceptor (and the associated mounting system) is described in detail, not because it forms, per se, part of the invention, but rather because attempts to change it provided a part of the motivation for the present invention. It should be noted that other methods of holding and electrifying the photoreceptor, may be used with the present invention.

### SUMMARY OF THE INVENTION

An aspect of some embodiments of the invention is related to methods and apparatus for avoiding scratches on photoreceptors, especially on organic photoreceptors. Although the invention is described in the context of a drum mounted photoreceptor sheet, in some embodiments of the invention, other configurations, such as coated continuous drum photoreceptors and belt type photoreceptors are useful in some embodiments of the invention.

In an attempt to simplify the construction of the photoreceptor sheets, the photoconductive and conductive layers were not removed from end 18 of photoreceptor 12. It was decided, correctly, that there would not be significant problems with the extra bump height that results. However, when this change was implemented, it was discovered that particles trapped under blade 22 (or some other part of the cleaning system) caused circumferential scratches in the surface of photoconductive layer 156. Furthermore, when the photoreceptor was formed without the conductive and photoconductive layers at end 18, the amount of scratching decreased over that present when the layers were removed chemically as in the past.

Measurements showed that the Mylar surface of the support layer had a higher coefficient of friction than the surface of the photoconductive layer. The Mylar surface has a lower coefficient of friction when it is exposed by chemical removal of the photoconductive and conductive layers than when the photoreceptor is produced without the layers being formed on the exposed portion of the Mylar. In an experiment, it was determined that the coefficients of friction, under conditions simulating operation of the system were very approximately in a ratio of 1:2:3 for the photoconductive surface, Mylar surface from which the overlayers are chemically removed and the Mylar surface when no overlayers are provided, respectively.

In an embodiment of the invention, a portion of the outer surface of the photoreceptor or of the uncovered base layer is roughened, either chemically or mechanically. This roughening, which increases the friction between trapped particles and the photoreceptor causes the particles to be released from under the cleaning blade, so that scratching does not occur. It is now believed that the rougher surface of the Mylar was effective in removing the particles from under the blade or other portion of the cleaning system. It is believed that, in addition to increasing the friction of the photoreceptor with the particles (and thus releasing the particles), the increased friction between the blade and the photoreceptor surface increases bending of the blade tip which aids in particle release.

The roughening can take the form of either simple roughening of the surface or of the formation of one or more groves in the surface of the photoreceptor (which grooves can comprise the absence of the photoconductive and conductive layers). More preferably, the grooves are made in a portion of the base layer that is not covered by the photoconductive layer and the conducting layer. While in principle, the grooves can be made in the photoconductive layer, such grooves cut through the conductive layer and expose it, which can cause problems in some parts of the system.

Optimally, the roughening should extend along the axis of the drum such that the particles are removed from the entire length. The rougher portion should extend in a circumferential direction by an amount sufficient to reliably remove the particles. This length may depend of the amount of roughening. This roughening must be low enough so that damage to the blade does not occur.

It is desirable for the roughening to be provided in a non-imaging portion of the photoreceptor, so that the image quality is not effected. However, it is believed that a slight roughening, sufficient to remove most or all trapped particles (and thus lengthen photoreceptor life considerably) can be achieved without substantial degradation of image quality and damage to the blade.

There is thus provided, in accordance with an exemplary embodiment of the invention, a photoreceptor comprising a support layer and a photoconductive layer, wherein at least a portion of an exposed surface of the photoreceptor is roughened.

In an embodiment of the invention, the at least a portion of the surface is chemically roughened. Optionally, the at least a portion of the exposed surface is chemically roughened after production of the surface. Alternatively or additionally, the at least a portion of the surface is mechanically roughened. Optionally, the at least a portion of the surface is mechanically roughened after production of the surface. Optionally, the mechanical roughening is produced by abrasion.

In an embodiment of the invention, wherein the photoreceptor is adapted to be used in an imaging system, with the photoreceptor being movable in one direction along the photoreceptor, the at least a portion of the photoreceptor comprises at least one roughened strip having a long direction substantially perpendicular to the direction of movement.

In an embodiment of the invention, the at least a portion of the photoconductive layer is formed with grooves that form said roughening. Optionally, the grooves are about 20 micrometers wide. Alternatively, the grooves are greater than about 20 micrometers wide. For example, between 20 and 30 micrometers wide, between 30 and 40 micrometers wide, between about 40 and about 50 micrometers wide or greater than 50 micrometers wide. Optionally, the grooves are less than about 100 micrometers wide.

Optionally, the grooves are less than about 20 micrometers deep. Alternatively, the grooves are between 20 and 30 micrometers deep, between 30 and 40 micrometers deep, between about 40 and about 50 micrometers deep or more than 50 micrometers deep. Optionally, the grooves are less than about 100 micrometers deep.

In an embodiment of the invention, the grooves are rectangular in cross section. In an embodiment of the invention, the grooves are triangular in cross section.

In an embodiment of the invention, the surface is a surface of a portion of the photoreceptor including the photoconductive layer. Alternatively, optionally, the surface is the surface of the support layer from which the photoconductive layer has been removed.

Optionally, the photoreceptor is roughened over substantially its entire active surface.

Optionally, the photoreceptor is a sheet photoreceptor adapted for mounting on a drum.

Optionally, the photoreceptor is a sheet photoreceptor adapted for mounting on a drum and wherein the at least one portion is situated adjacent to an edge thereof.

Optionally, the photoreceptor is a drum photoreceptor. Optionally, the photoreceptor is a belt photoreceptor. Optionally, the photoreceptor is seamless. Alternatively, the photoreceptor has a seam.

There is further provided, in accordance with an embodiment of the invention, a method of manufacturing a photoreceptor comprising:

providing a support surface;

overlaying a conducting layer on a portion of the support surface, without overlaying at least a portion of the support surface; and

overlaying at least a portion of the conductive layer with a photoconductive layer without overlaying at least a portion of the support surface, such that a portion of the support surface is not covered with either conducting or photoconductive layers.

Optionally, the support surface is the surface of a plastic material. Optionally, the material is Mylar.

In an embodiment of the invention, the support surface is the surface of a sheet. Optionally, the portion of the sheet that is not covered by the layers is along an edge of the sheet, leaving the support surface bare. Optionally, a portion of the conducting layer is not overlayed by the photoconductive layer along an edge of the sheet, leaving the conducting layer bare. In an embodiment of the invention, the bare conducting layer and support surfaces are at opposite edges of the sheet.

In an embodiment of the invention, the photoreceptor is a belt photoreceptor. Optionally, the bare portion of the support surface lies across the width of the belt.

In an embodiment of the invention, the photoreceptor is a drum photoreceptor. Optionally, the bare portion of the support surface lies across the height of the drum.

### BRIEF DESCRIPTION OF THE DRAWINGS

Exemplary, non-limiting embodiments of the invention are described with reference to the attached drawings. In the drawings, which are sized for convenience of discussion and are not necessarily to scale, like reference symbols are used in more than one drawing to designate the same or equivalent features. The drawings are:

FIG. 1A is a schematic cross-sectional view of a drum having a photoreceptor mounted thereon, in accordance with the prior art;

FIG. 1B is a schematic cross-sectional view of a mounting mechanish for mounting a photoreceptor, in accordance with the prior art;

FIG. 2A is a top view of a photoreceptor, in accordance with the prior art;

FIGS. 2B-2D are partial cross-sectional views of the photoreceptor of the ends of the photoreceptor of FIG. 2A;

FIG. 3A shows a conceptual drawing of a particle trapped between a scrapper blade and a surface;

FIG. 3B shows a conceptual drawing of the removal of a particle from a blade/surface interface, when the blade is juxtaposed with a roughened portion of the surface, in accordance with an embodiment of the invention;

FIG. 4 shows a schematic cross-sectional view of photoreceptor having a grooved surface portion, in accordance with an embodiment of the invention; and

FIG. 5 is a schematic top view of a sheet photoreceptor for mounting on a drum, in accordance with an embodiment of the invention.

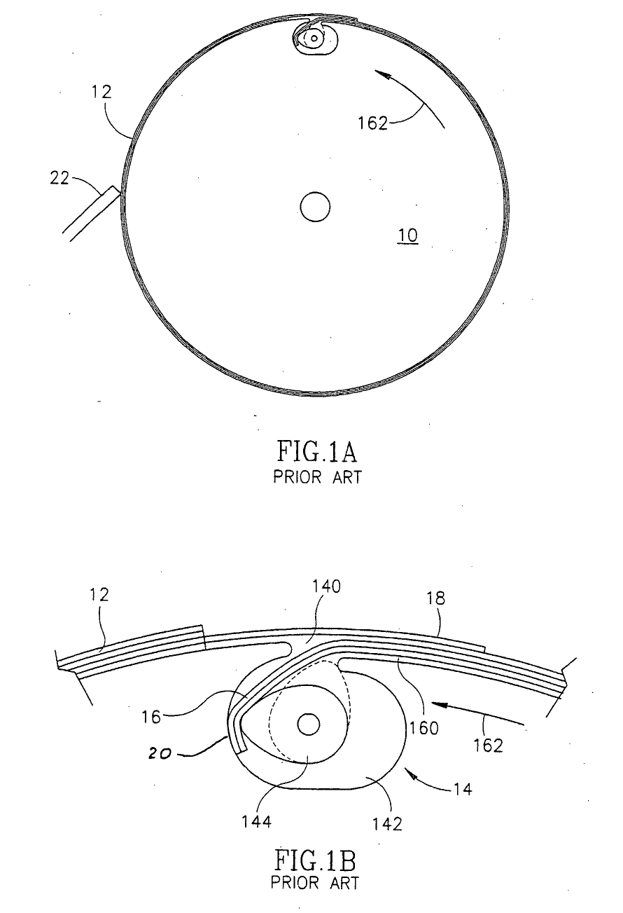

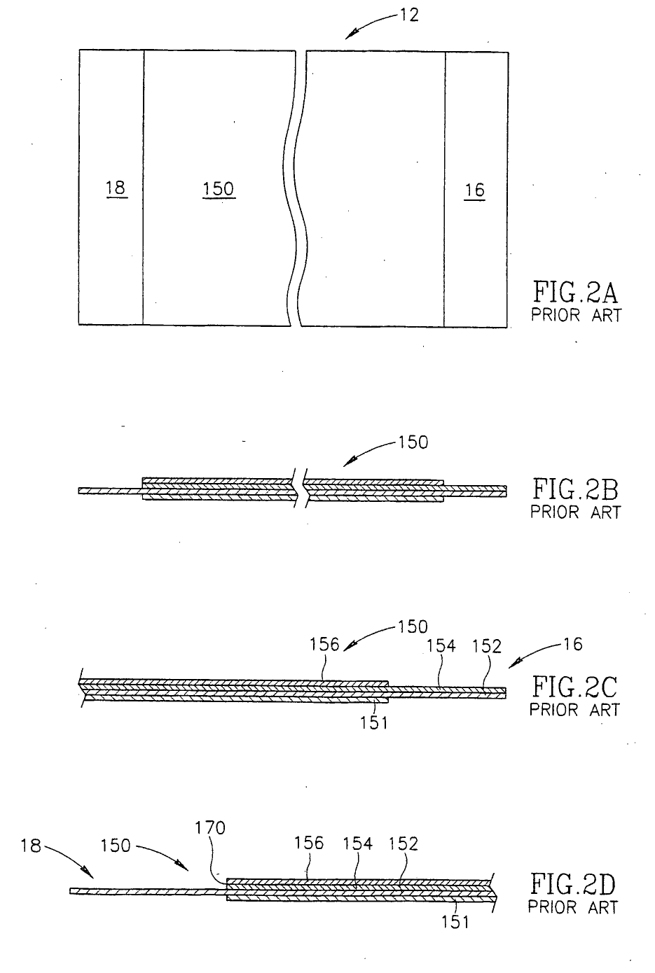

### DESCRIPTION OF EXEMPLARY EMBODIMENTS

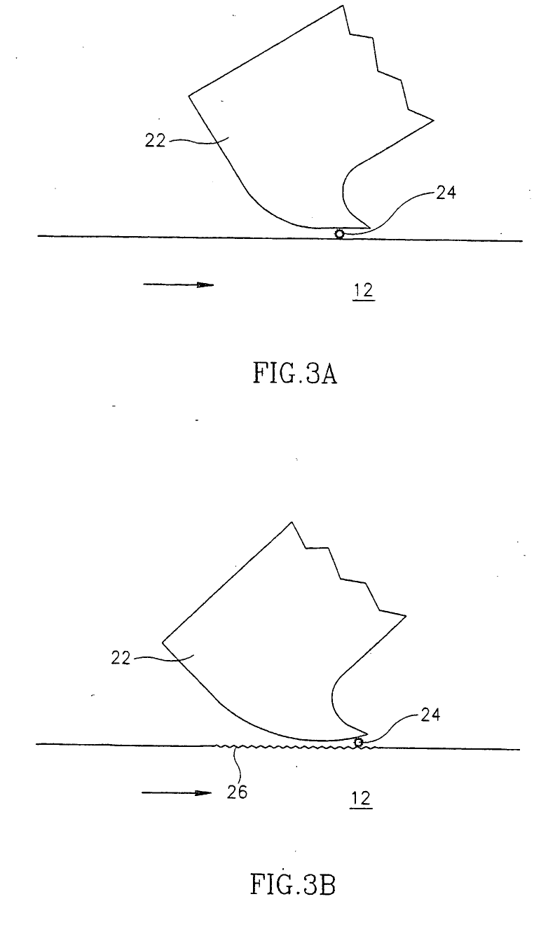

FIG. 3A shows a conceptual drawing (not to scale) of a particle 24 trapped between scrapper blade 22 and a surface, such as the surface of photoreceptor 12. The amount of bending of the blade is exaggerated in this figure. Because of the pressure with which blade 22 is pressed against photoreceptor 12, a particle may be trapped between the blade and the photoreceptor. In general, the photoreceptor surface is made very smooth in order for it to release the toner image formed on it with minimum residual, untransferred toner. Thus, since the coefficient of friction of particle 24 with blade 22 than it is with photoreceptor 12, particle 24 is carried along with the blade and may scratch the photoreceptor surface.

It has been found that roughening the surface as by forming it with one or more grooves or by chemical or mechanical roughening will increase the coefficient of friction with the particle so that it is not drawn along with the blade. This increase in friction may cause the particle to remain stationary on the photoreceptor or to roll along the surface of the photoreceptor until it is released at the end of the blade.

FIG. 3B shows, conceptually, what happens when blade 22 and particle 24 reach a roughened portion 26. At this portion, the friction force between blade 22 and particle 24 is lower than the frictional force between photoreceptor 12 and particle 24, such that the particle is removed, by friction from the blade. It is believed that, in addition to increasing the friction of the photoreceptor with the particles (and thus releasing the particles), the increased friction between the blade and the photoreceptor surface increases bending of the blade tip and aids in particle release.

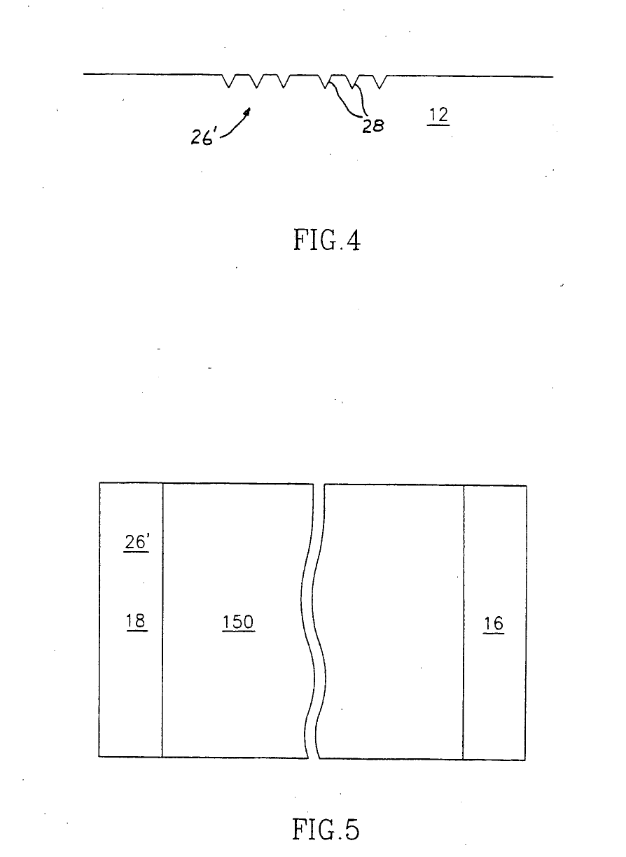

FIG. 4 shows a cross-sectional view of a photoreceptor 12 in which a roughened portion 26′ is generated by forming grooves 28 in the photoreceptor. These grooves may be formed by etching, laser scribing, grooving with a knife or scratching the photoreceptor or by not coating support layer 152 with the upper layers. While triangular grooves are shown, other groove shapes, such as rectangular can be used.

As indicated above, in the summary, the level of scratching is highest when the backing layer is not exposed, much lower when the photoconductive and conducting layers are removed chemically and even lower when these layers are not formed at all over the backing layer. However, while the problem of scratches is reduced, scratching may not be completely removed by any of these measures.

Applicants have found that increasing the depth of the grooves up to 50 micrometers in depth and width is effective to further decrease the amount of scratching. While there does not appear to be a threshold for the effect, significant improvement is found with grooving that is 20 micrometers deep. The depth of the grooves is limited by the present thickness of the base layer (experimental grooving has been performed on bare backing layers), namely 70 micrometers. It is believed that deeper grooves and or grooves with larger internal areas (such as square or rectangular grooves) may provide better capture and release of the particles.

For the present construction, the reduction of scratching increases with the number of grooves. This is believed to be a statistical phenomenon. However, even a single groove has a desirable effect. In general 1-10 grooves may be formed.

The grooves may be formed by drawing a shaped tool over the surface, by laser milling, by chemical etching or by other means known in the art. The surfaces may be roughened by abrasive action of a powder or a solid block or by the action of a chemical such as a Phenol, Nitrobenzene or Carbolic acid.

FIG. 5 shows a top view of a sheet photoreceptor formed with roughened portion 26′. As shown, the roughened portion is a strip with its long dimension in the direction of the drum axis (when mounted). However, it may be advantageous, especially when the surface is grooved, to form the groves at an angle with the axial direction, since this may aid in the removal of the particles from the blade. This angling also helps to reduce wear on the scrapper, which is generally of a polymer such as polyurethane having a Shore A hardness of between 50 and 80.

It should be noted that the rough portion is situated near edge 18. Thus, any intrinsic effect of the roughness on the quality of images formed on the photoreceptor will not effect the images actually formed, since this portion is not used in forming the images. In systems in which a “seam” exists in the photoreceptor, the photoreceptor (blanket, drum or belt) and the paper feed must be synchronously operated so that the seam is not positioned in the image.

However, in systems which the photoreceptor (drum or belt) does not rotate once (or once divided by an integer), for each image produced, there is no “safe” area on the photoreceptor in which the image quality can be reduced. It is believed that a small amount of roughening, for example by chemical etching could be found which would not deteriorate the image quality to an unacceptable degree, but would provide enough roughness to avoid particles being trapped under the scrapper or other parts of the cleaning system. In some embodiments of the invention, a substantial portion, or all, of the surface is roughened. It is noted that excessive roughness might cause difficulty in transfer of the image from the photoreceptor or scatter of the laser light that forms a latent image in the photoreceptor reducing the quality of the image.

The present invention has been described using non-limiting detailed descriptions of exemplary embodiments thereof that are provided by way of example and that are not intended to limit the scope of the invention. Variations of embodiments of the invention, including combinations of features from the various embodiments, will occur to persons of the art. Furthermore, a number of embodiments and variations are presented, it being understood that some of the embodiments may be combined and/or that some features of the embodiments presented may be omitted. The scope of the invention is thus limited only by the scope of the claims. The terms “comprise,” “include,” “have” or their conjugates, in the claims, mean “including but not necessarily limited to”.

1. A photoreceptor for use in an imaging system, with the photoreceptor being adapted for movement in one direction along the photoreceptor, comprising a support layer and a photoconductive layer, wherein at least one strip having a long direction substantially perpendicular to the direction of movement of an exposed surface of the photoreceptor is roughened.

2. A photoreceptor according to claim 1 wherein the at least one strip is chemically roughened.

3. A photoreceptor according to claim 1 wherein the at least one strip is chemically roughened after production of the surface.

4. A photoreceptor according to claim 1 wherein the at least one strip is mechanically roughened.

5. A photoreceptor, according to claim 4 wherein the at least one strip is mechanically roughened after production of the surface.

6. A photoreceptor according to claim 4 wherein the mechanical roughening is produced by abrasion.

7. A photoreceptor according to claim 1 wherein the at least one strip is formed with grooves that form said roughening.

8. A photoreceptor according to claim 7 wherein the grooves are about 20 micrometers wide.

9. A photoreceptor according to claim 8 wherein the grooves are greater than about 20 micrometers wide.

10. A photoreceptor according to claim 9 wherein the grooves are between 20 and 30 micrometers wide.

11. A photoreceptor according to claim 9 wherein the grooves are between 30 and 40 micrometers wide.

12. A photoreceptor according to claim 9 wherein the grooves are between about 40 and about 50 micrometers wide.

13. A photoreceptor according to claim 9 wherein the grooves more than 50 micrometers wide.

14. A photoreceptor according to claim 7 wherein the grooves are less than about 100 micrometers wide.

15. A photoreceptor according to claim 7 wherein the grooves are less than about 20 micrometers deep.

16. A photoreceptor according to claim 7 wherein the grooves are between 20 and 30 micrometers deep.

17. A photoreceptor according to claim 7 wherein the grooves are between 30 and 40 micrometers deep.

18. A photoreceptor according to claim 7 wherein the grooves are between about 40 and about 50 micrometers deep.

19. A photoreceptor according to claim wherein the grooves are more than 50 micrometers deep.

20. A photoreceptor according to claim 7 wherein the grooves are less than about 100 micrometers deep.

21. A photoreceptor according to claim 7 wherein the grooves are rectangular in cross section.

22. A photoreceptor according to claim 7 wherein the grooves are triangular in cross section.

23. A photoreceptor according to claim 1 wherein the at least one roughened strip is formed on a surface of a portion of the photoreceptor including the photoconductive layer.

24. A photoreceptor according to claim 1 wherein the at least one strip is the surface of the support layer from which the photoconductive layer has been removed.

25. A photoreceptor according to claim 1 wherein the photoreceptor is a sheet photoreceptor adapted for mounting on a drum.

26. A photoreceptor according to claim 1 wherein the photoreceptor is a sheet photoreceptor adapted for mounting on a drum and wherein the at least one portion is situated adjacent to an edge thereof.

27. A photoreceptor according to claim 1 wherein the photoreceptor is a drum photoreceptor.

28. A photoreceptor according to claim 1 wherein the photoreceptor is a belt photoreceptor.

29. A photoreceptor according to claim 27, wherein the photoreceptor is seamless.

30. A photoreceptor according to claim 27 wherein the photoreceptor has a seam.

31. A method of manufacturing a photoreceptor adapted to be used in an imaging system, with the photoreceptor adapted to be movable in one direction along the photoreceptor, the method comprising:
providing a support surface;
overlaying a conducting layer on a portion of the support surface, without overlaying at least one strip of the support surface perpendicular to the motion direction; and
overlaying at least a portion of the conductive layer with a photoconductive layer without overlaying at at least one strip of the support surface perpendicular to the motion direction, such that a portion of the support surface is covered with neither conducting or photoconductive layers.

32. A method according to claim 31 wherein the support surface is the surface of a plastic material.

33. A method according to claim 32 wherein the material is Mylar.

34. A method according to claim 30 wherein the support surface is the surface of a sheet.

35. A method according to claim 34 wherein the portion of the sheet that is not covered by the layers is along an edge of the sheet, leaving the support surface bare.

36. A method according to claim 34 wherein a portion of the conducting layer is not overlayed by the photoconductive layer along an edge of the sheet, leaving the conducting layer bare.

37. A method according to claim 34 wherein the bare conducting layer and support surfaces are at opposite edges of the sheet.

38. A method according to claim 30 wherein the photoreceptor is a belt photoreceptor.

39. A method according to claim 38 wherein the bare portion of the support surface lies across the width of the belt.

40. A method according to claim 30 wherein the photoreceptor is a drum photoreceptor.

41. A method according to claim 40 wherein the bare portion of the support surface lies across the height of the drum.
